(19) United States
(12) Patent Application Publication
(10) Pub. No.: US 2026/0259444 A1
(43) Pub. Date: Sep. 3, 2026

(54) CURVABLE BRACKET AND CURVED DISPLAY DEVICE INCLUDING SAME

(71) Applicant: KORTEK CORPORATION, Incheon (KR)

(72) Inventors: Kyoung Woon BAE, Chilgok-gun Gyeongsangbuk-do (KR); Yeong Sung HAN, Paju-si Gyeonggi-do (KR)

(21) Appl. No.: 19/165,215

(22) PCT Filed: Mar. 6, 2024
(86) PCT No.: PCT/KR2024/002890

§ 371 Date: Sep. 15, 2025

(30) Foreign Application Priority Data
Mar. 20, 2023 (KR) 10-2023-0035629

(51) Int. Cl. G02F 1/1333

(52) U.S. Cl. CPC G02F 1/133308

(57) ABSTRACT

A curvable bracket and a curved display device including same is provided, wherein the curvable bracket includes: a base part extending along a curved edge of a curved display panel; and a plurality of pieces that are bent and protrude from one side edge of the base part so as to cover the curved edge, are connected only to the base unit and are separated from each other, and are arranged in a line in the longitudinal direction of the base part.

### CROSS REFERENCE TO RELATED APPLICATIONS

This application is a national application of PCT Application No. PCT/KR2024/002890, having a filing date of Mar. 6, 2024, which claims priority to KR Application No. 10-2023-0035629, having a filing date of Mar. 20, 2023, the entire contents both of which are hereby incorporated by reference.

### FIELD OF TECHNOLOGY

The following relates to a display device, and more specifically, to a curvable bracket which supports a curved display panel and a curved display device including the same.

### BACKGROUND

A display device is a device, such as a monitor, which receives an image signal and displays an image such as a still image or a moving image on a front surface. Recently, a display device includes a thin and wide display panel, and the size of a screen is gradually increasing.

Among display devices, a curved display device including a curved display panel rather than a flat display panel increases immersion and concentration in games or work and thus is popular. The curved display device includes a curved display panel and a curved bracket which fixes and supports an edge of the curved display panel.

Conventionally, an allowable tolerance level between the curvature of the curved bracket and the curvature of the edge of the curved display panel was very small. Accordingly, there is a problem in that the yield of the curved bracket or the curved display panel is low, and thus the production cost of the curved display device increases. Further, even when an error between the curvature of the curved bracket and the curvature of the edge of the curved display panel is within the tolerance, since stress between the assembled curved bracket and curved display panel is large, the curved bracket or the curved display panel may be easily damaged or have reduced durability.

The background technology of embodiments of the present invention is disclosed in Korean Patent Publication No. 10-2282937 (registered on Jul. 22, 2021, title of the invention: Curved Display Device).

### SUMMARY

An aspect relates to improving the above-described problems and provides a curvable bracket whose curvature may be changed according to the curvature of an edge of a curved display panel, and a curved display device including the same.

A curvable bracket according to embodiments of the present invention includes: a base part extending along a curved edge of a curved panel; and a plurality of pieces that are bent and protrude from one side edge of the base part to cover the curved edge, are connected to only the base part and separated from each other, and are arranged in a line in a longitudinal direction of the base part.

The curvature of the base part may change when an angle between a pair of neighboring pieces among the plurality of pieces changes.

A slit extending in a direction orthogonal to the longitudinal direction of the base part may be formed between the pair of neighboring pieces, and the angle between the pair of neighboring pieces may be an angle between a pair of edges that face each other and define the slit.

The plurality of pieces may each have a quadrangular plate shape.

A curved display device according to embodiments of the present invention includes: a curved display panel having a screen curved in a curved shape and including at least one curved edge; and a curvable bracket including a base part extending along the curved edge, and a plurality of pieces that are bent and protrude from one side edge of the base part to cover the curved edge, are connected to only the base part and separated from each other, and are arranged in a line in a longitudinal direction of the base part.

The curved display panel may include a liquid crystal panel curved in a curved shape; and a backlight unit curved in a curved shape corresponding to the liquid crystal panel and disposed to overlap the rear of the liquid crystal panel to irradiate light toward the liquid crystal panel.

The backlight unit may include a backlight panel curbed in a curved shape corresponding to the liquid crystal panel; and a curved backlight bracket supported on a curved edge of the backlight panel and extending to overlap the plurality of pieces, and some of the plurality of pieces may be coupled to the curved backlight bracket.

The curved display device according to embodiments of the present invention may further include a chip on film (COF) having one end portion electrically connected to electrodes distributed on the liquid crystal panel; and a source printed circuit board (PCB) to which the other end portion of the COF is electrically connected.

The curved display device according to embodiments of the present invention may further include a PCB holder that supports the source PCB and is fixed to a back surface of the backlight panel, wherein the COF may cover the curved backlight bracket and may be connected to the electrodes distributed on the liquid crystal panel and the source PCB.

Since the curvature of a curvable bracket of embodiments of the present invention can change according to the curvature of a curved edge of a curved display panel, the allowable tolerance between the curved edge of the curved display panel and the curvable bracket is expanded. Accordingly, when the curvable bracket is assembled to the curved display panel, assembly defects are reduced, the productivity of the curved display device is enhanced, and the production cost of the curved display device is reduced.

According to embodiments of the present invention, since stress between the assembled curved bracket and curved display panel is reduced, the curvable bracket or the curved display panel is not damaged, and durability is enhanced.

### BRIEF DESCRIPTION

Some of the embodiments will be described in detail, with references to the following Figures, wherein like designations denote like members, wherein:

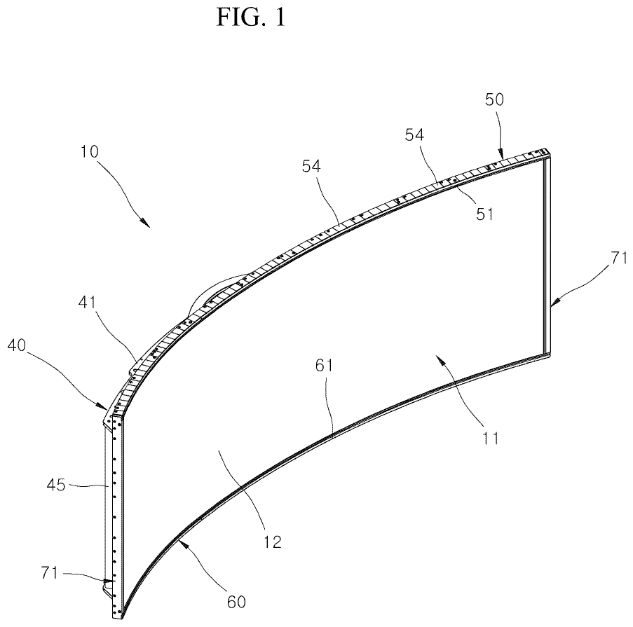

FIG. 1 depicts a front perspective view of a curved display device according to an embodiment of the present invention;

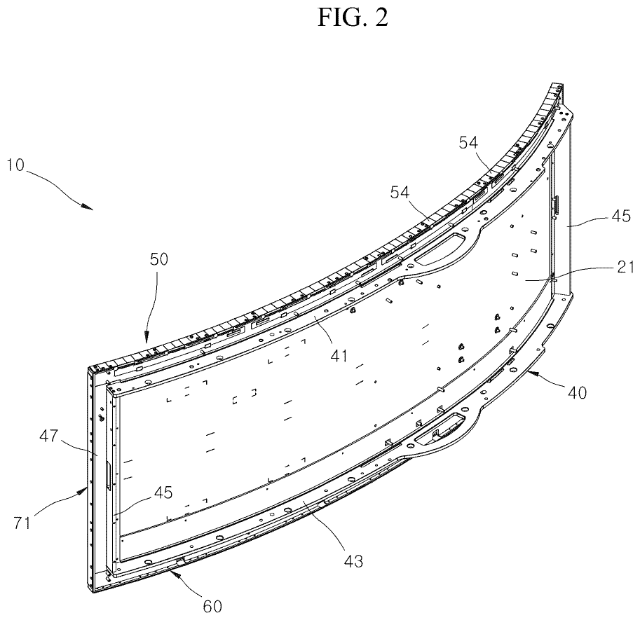

FIG. 2 depicts a rear perspective view of the curved display device according to an embodiment of the present invention;

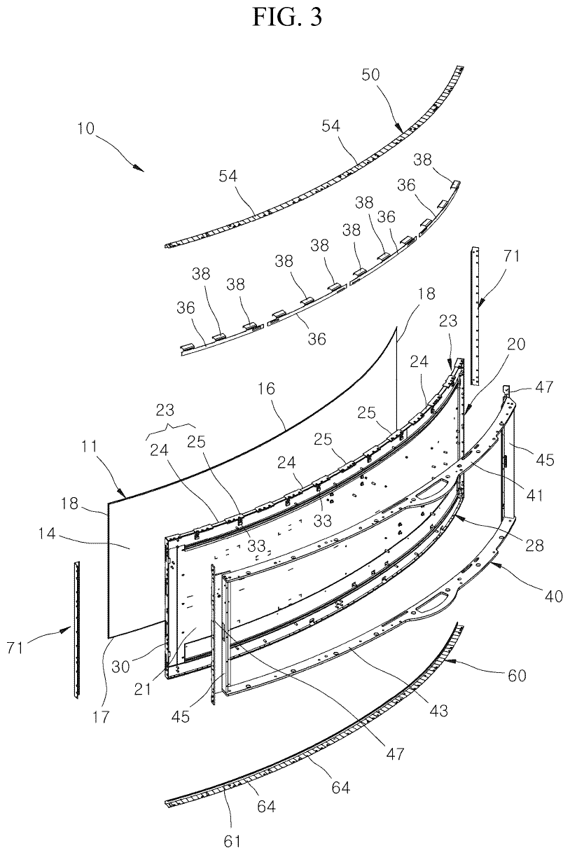

FIG. 3 depicts an exploded perspective view of the curved display device in FIG. 2;

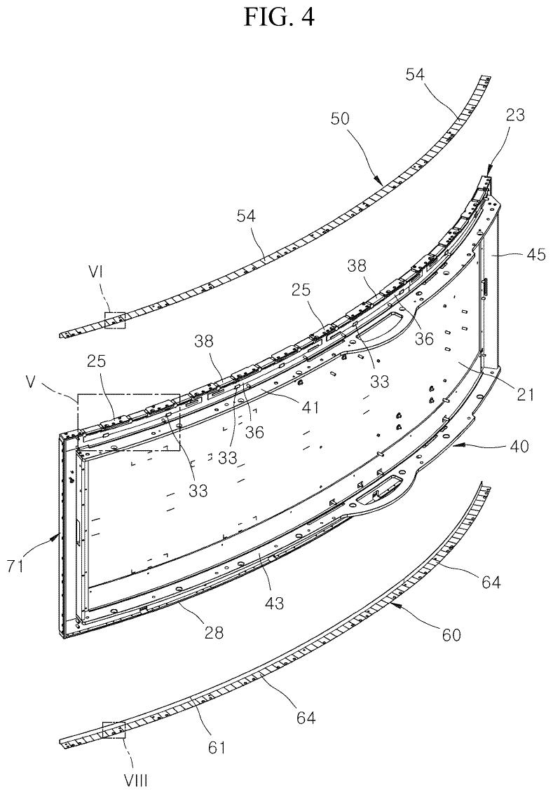

FIG. 4 depicts a partially exploded perspective view illustrating a state in which upper and lower curvable brackets are separated;

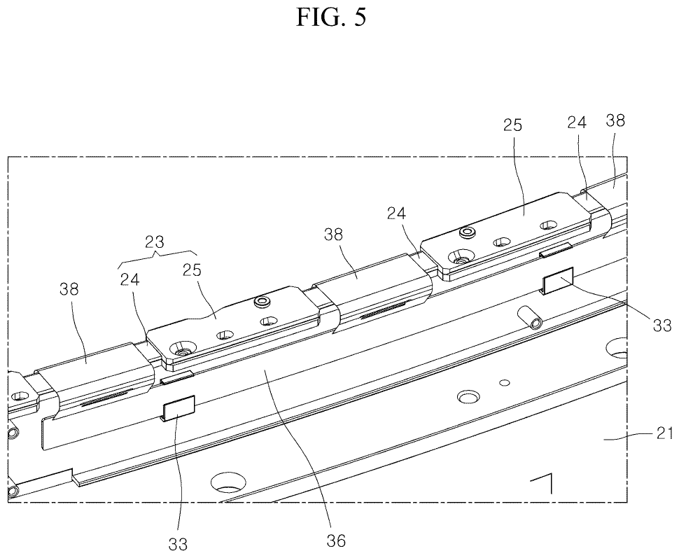

FIG. 5 depicts an enlarged view of portion V in FIG. 4;

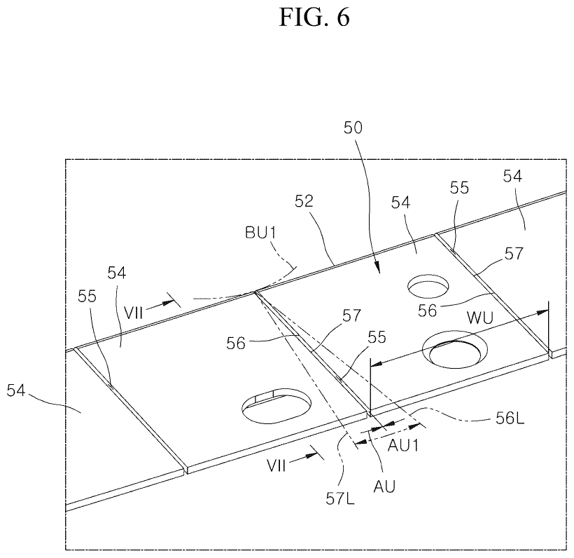

FIG. 6 depicts an enlarged view of portion VI in FIG. 4;

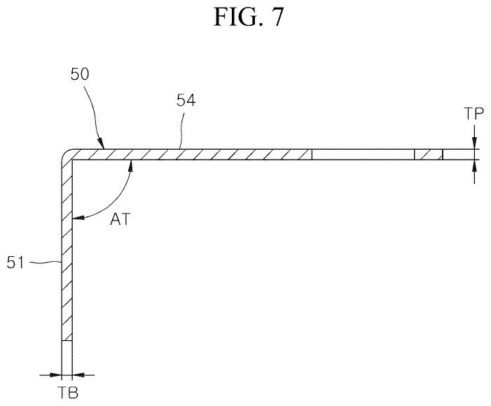

FIG. 7 depicts a cross-sectional view taken along line VII-VII in FIG. 6; and

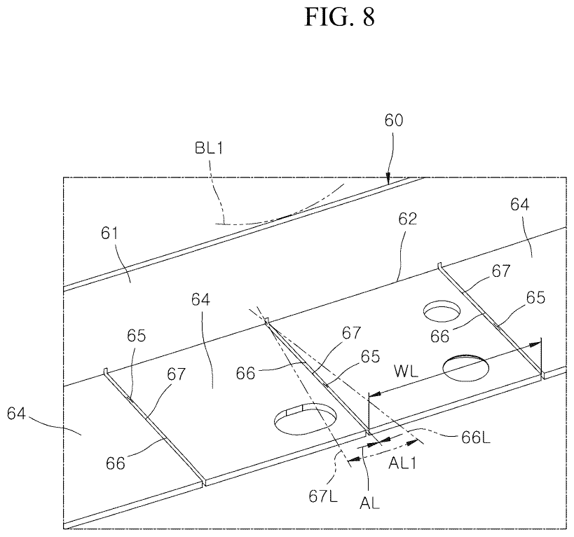

FIG. 8 depicts an enlarged view of portion VIII in FIG. 4;

### DETAILED DESCRIPTION

Hereinafter, a curvable bracket and a curved display device including the same according to an embodiment of the present invention will be described in detail with reference to the attached drawings. The terms used in the present specification are terms used to appropriately express embodiments of the present invention and may vary depending on the intention of the user or operator, or customary practices in the field to which embodiments of the present invention belong. Accordingly, the definitions of these terms should be made based on the contents throughout the present specification.

FIG. 1 is a front perspective view of a curved display device according to an embodiment of the present invention, FIG. 2 is a rear perspective view of the curved display device according to an embodiment of the present invention, FIG. 3 is an exploded perspective view of the curved display device in FIG. 2, FIG. 4 is a partially exploded perspective view illustrating a state in which upper and lower curvable brackets are separated, FIG. 5 is an enlarged view of portion V in FIG. 4, FIG. 6 is an enlarged view of portion VI in FIG. 4, FIG. 7 is a cross-sectional view taken along line VII-VII in FIG. 6, and FIG. 8 is an enlarged view of portion VIII in FIG. 4.

Referring to FIGS. 1 to 4, a curved display device 10 according to an embodiment of the present invention includes curved display panels 11 and 20, a plurality of source printed circuit boards (PCBs) 36, a plurality of chip on films (COFs) 38, a plurality of PCB holders 33, a backlight unit support frame 40, upper and lower curvable brackets 50 and 60, and a pair of side straight brackets 71. The curved display device 10 may be installed, for example, inside a case of an arcade game machine, a case of a slot machine, or a case of a monitor.

The curved display panels 11 and 20 are display panels whose screens are curved in a curved shape and may include a curved-shaped liquid crystal display (LCD) panel. The curved-shaped LCD panel includes a liquid crystal panel 11 curved in a curved shape and a backlight unit (BLU) 20 curved in a curved shape corresponding to the liquid crystal panel 11 and disposed to overlap the rear of the liquid crystal panel 11.

The backlight unit 20 projects white light forward, that is, toward the liquid crystal panel 11. The liquid crystal panel 11 is disposed in front of the backlight unit 20 and selectively transmits the white light projected from the backlight unit 20. The liquid crystal panel 11 includes a front substrate and a back substrate which are parallel to each other and transparent, a liquid crystal layer, a front polarizing film, and a back polarizing film.

The liquid crystal layer is interposed between the front substrate and the back substrate. Transparent electrodes (not shown) are formed on the back surface of the front substrate and the front surface of the back substrate facing each other with the liquid crystal layer therebetween so that an electrical signal is applied to each pixel. When the electrical signal is applied to a specific pixel through the transparent electrodes, a twisted liquid crystal is untwisted, or conversely, the liquid crystal is twisted depending on the liquid crystal type.

The front polarizing film is attached to the front surface of the front substrate, and the back polarizing film is attached to the back surface of the back substrate. The front substrate to which the front polarizing film is attached is also called a front polarizing panel, and the back substrate to which the back polarizing film is attached is also called a back polarizing panel.

A curved rectangular plate shape of the liquid crystal panel 11 is defined by a pair of curved edges 16 and 17 and a pair of straight edges 18. Specifically, the shape of the curved liquid crystal panel 11 is defined by an upper curved edge 16, a lower curved edge 17, and the pair of side straight edges 18.

The backlight unit 20 may include a light diffusion plate curved in a curved shape corresponding to the curved shape of the liquid crystal panel 11 and a backlight light source which projects light from the rear of the light diffusion plate to the back surface of the light diffusion plate. The backlight light source may include a plurality of light-emitting diode (LED) packages.

The backlight unit 20 may further include a backlight panel 21, an upper curved backlight bracket 23, a lower curved backlight bracket 28, and a pair of side straight backlight brackets 30. The backlight panel 21 is curved in a curved shape corresponding to the curved surface shape of the liquid crystal panel 11. In other words, the shape of the backlight panel 21 is a curved rectangular shape similar to the shape of the liquid crystal panel 11. The backlight light source may be mounted on the backlight panel 21.

The upper curved backlight bracket 23 may be supported on the upper curved edge of the backlight panel 21, and the lower curved backlight bracket 28 may be supported on the lower curved edge of the backlight panel 21. The pair of side straight backlight brackets 30 may be supported on the pair of side straight edges of the backlight panel.

Referring to FIGS. 3 to 5, the upper curved backlight bracket 23 may include a plurality of narrow rail portions 24 and a plurality of wide rail portions 25 alternately arranged in a line along the upper curved edge of the backlight panel 21. A width of the wide rail portion 25 is wider than a width of the narrow rail portion 24. The plurality of wide rail portions 25 may be coupled to the upper curvable bracket 50 by screw fastening (not shown).

The plurality of source PCBs 36 and the plurality of COFs 38 may be provided to apply electrical signals to the transparent electrodes of the liquid crystal panel 11. One end portions of the plurality of COFs 38 may be electrically connected to transparent electrodes distributed on the liquid crystal panel 11, and the other end portions may be electrically connected to the plurality of source PCBs 36.

The plurality of source PCBs 36 may be arranged in a line on the back surface of the backlight panel 21. The plurality of PCB holders 33 may be fixed to the back surface of the backlight panel 21, and the plurality of source PCBs 36 may be fitted and fixed to the plurality of PCB holders 33. The plurality of COFs 38 may partially cover the upper curved backlight bracket 23 and may be connected to the transparent electrodes distributed on the liquid crystal panel 11 and the plurality of source PCBs 36. Specifically, the plurality of COFs 38 may cover the narrow rail portions 24 to overlap the plurality of narrow rail portions 24 one by one and may be connected to the transparent electrodes and the source PCBs 36.

The backlight unit support frame 40 is attached to the backlight panel 21 and supports the backlight unit 20 to prevent deformation. The backlight unit support frame 40 may include an upper curved beam 41 and a lower curved beam 43 spaced apart up and down and a pair of side straight beams 45 which vertically extend while connecting an end portion of the upper curved beam 41 to an end portion of the lower curved beam 43.

The backlight unit support frame 40 may further include a pair of side surface connection brackets 47 whose one side is coupled to the pair of side straight beams 45 and the other side is coupled to the pair of side straight backlight brackets 30. The backlight unit support frame 40 is fixedly coupled to the backlight unit 20 by the pair of side surface connection brackets 47.

Referring to FIGS. 1 to 7, the upper curvable bracket 50 includes a base part 51 and a plurality of pieces 54. The base part 51 extends with a constant width along the upper curved edge 16.

The plurality of pieces 54 are bent and protrude from one side edge 52 of the base part 51 to cover the upper curved edge 16 and the upper curved backlight bracket 23. The plurality of pieces 54 are connected to only one side edge 52 of the base part 51, and neighboring pieces 54 are separated from each other and are arranged in a line in a longitudinal direction of the base part 51.

The plurality of pieces 54 may each have a rectangular plate shape. When each of the pieces 54 has a rectangular shape, a slit 55 extending in a direction orthogonal to the longitudinal direction of the base part 51 may be formed between a pair of neighboring pieces 54. In this case, an angle AU between the pair of neighboring pieces 54 may be an angle between a pair of edges 56 and 57 which face each other and define the slit 55.

When the angle AU between the pair of neighboring pieces 54 among the plurality of pieces 54 changes, the curvature of the base part 51 may change. The curvature of the base part 51 means the curvature of an imaginary line extending along the longitudinal direction of the base part 51.

Referring to FIG. 6, for example, when the longitudinal direction of the base part 51 is a straight direction, that is, when the one side edge 52 of the base part 51 extends along a straight line, the angle AU between the pair of neighboring pieces 54, that is, the angle AU between the pair of edges 56 and 57 facing each other, may be 0°.

When the base part 51 is curved and thus the longitudinal direction of the base part 51 becomes a curved direction along a curved line BUI formed by a dash-double dotted line, the pair of neighboring edges 56 and 57 may move to the position of the straight lines 56L and 57L formed by dash-double dotted lines. Accordingly, the slit 55 may be widened with respect to the dead end of the slit 55 as a center, and the angle AU1 between the pair of neighboring pieces 54 may increase.

Since the base part 51 may be curved to have a large curvature while the angle AU between the pair of neighboring pieces 54 changes according to the curvature of the upper curved edge 16, an allowable tolerance range between the curved display panels 11 and 20, specifically, the curved liquid crystal panel 11 and the upper curvable bracket 50 is expanded.

Accordingly, when the upper curvable bracket 50 is assembled to the curved display panels 11 and 20, assembly defects are reduced, the productivity of the curved display device 10 is enhanced, and the production cost of the curved display device 10 is reduced.

Further, even when the base part 51 is curved to have a large curvature, since the internal stress of the upper curvable bracket 50 is not excessively increased while the angle AU between the pair of neighboring pieces 54 is enlarged, the upper curvable bracket 50 or the curved display panels 11 and 20 are not damaged and durability is enhanced.

A thickness TB of the base part 51 and a thickness TP of the piece 54 may be, for example, 0.2 to 2.0 mm. The bending angle AT of the piece 54 bent with respect to the base part 51 may be, for example, 88 to 92°.

When the shape of the piece 54 is a rectangular plate shape, a length WU of the piece 54 in a direction parallel to the longitudinal direction of the base part 51 may be, for example, 10 to 30 mm. When the curvature of the curved liquid crystal panel 11 is 200 R to 3000 R, that is, when a radius of curvature is 200 to 3000 mm, and the length WU of the piece 54 is 10 to 30 mm, the maximum interval between the base part 51 and the upper curved edge 16 of the liquid crystal panel 11 may be managed to be 0.1 mm or less.

Some of the plurality of pieces 54 and the upper curved backlight bracket 23 may be coupled by screw fastening. Specifically, the plurality of wide rail portions 25 and the plurality of pieces 54 overlapping the plurality of wide rail portions 25 may be coupled by screw fastening. Accordingly, the upper curvable bracket 50 is fixedly coupled to the backlight unit 20.

Referring to FIGS. 1 to 4 and FIG. 8, the lower curvable bracket 60 includes a base part 61 and a plurality of pieces 64. The base part 61 extends with a constant width along the lower curved edge 17.

The plurality of pieces 64 are bent and protrude from one side edge 62 of the base part 61 to cover the lower curved edge 17 and the lower curved backlight bracket 28. The plurality of pieces 64 are connected only to one side edge 62 of the base part 61, and neighboring pieces 64 are separated from each other and are arranged in a line in a longitudinal direction of the base part 51.

The plurality of pieces 64 may each have a rectangular plate shape. When each of the pieces 64 has a rectangular shape, a slit 65 extending in a direction orthogonal to the longitudinal direction of the base part 61 may be formed between a pair of neighboring pieces 64. In this case, an angle AL between the pair of neighboring pieces 64 may be an angle between a pair of edges 66 and 67 which face each other and define the slit 65.

When the angle AL between the pair of neighboring pieces 64 among the plurality of pieces 64 changes, the curvature of the base part 61 may change. The curvature of the base part 61 means the curvature of an imaginary line extending along the longitudinal direction of the base part 61.

Referring to FIG. 8, for example, when the longitudinal direction of the base part 61 is a straight direction, that is, when one side edge 62 of the base part 61 extends along a straight line, the angle AL between the pair of neighboring pieces 64, that is, the angle AL between the pair of edges 66 and 67 facing each other may be 0°.

However, when the base part 61 is curved and thus the longitudinal direction of the base part 61 becomes a curved direction along a curved line BLI formed by a dash-double dotted line, the pair of neighboring edges 66 and 67 may move to the position of the straight lines 66L and 67L formed by dash-double dotted lines. Accordingly, the slit 65 may be widened with respect to a dead end of the slit 65 as a center, and the angle AL1 between the pair of neighboring pieces 64 may increase.

Since the base part 61 may be curved to have a large curvature while the angle AL between the pair of neighboring pieces 64 changes according to the curvature of the lower curved edge 17, an allowable tolerance range between the curved display panels 11 and 20, specifically, the curved liquid crystal panel 11 and the lower curvable bracket 60 is expanded.

Accordingly, when the lower curvable bracket 60 is assembled to the curved display panels 11 and 20, assembly defects are reduced, the productivity of the curved display device 10 is enhanced, and the production cost of the curved display device 10 is reduced.

Further, even when the base part 61 is curved to have a large curvature, since the internal stress of the lower curvable bracket 60 is not excessively increased while the angle AL between the pair of neighboring pieces 64 is enlarged, the lower curvable bracket 60 or the curved display panels 11 and 20 are not damaged and durability is enhanced.

A thickness of the base part 61 of the lower curvable bracket 60, a thickness of the piece 64, a bending angle of the piece 64 bent with respect to the base part 61, and a length of the piece 64 in a direction parallel to the longitudinal direction of the base part 61 may be the same as the corresponding specifications of the above-described upper curvable bracket 50. Some of the plurality of pieces 64 and the lower curved backlight bracket 28 may be coupled by screw fastening.

Referring to FIGS. 1 to 4, the pair of side straight brackets 71 are members having ‘L’-shaped cross-sections and may extend in a straight path to overlap the pair of side straight edges 18 and the pair of side straight backlight brackets 30. The pair of side straight brackets 71 may each include a base part, and a side surface covering portion that is bent and protrudes from the base part. The side surface covering portion may be fixedly coupled to the side straight backlight bracket 30 by screw fastening.

The base part 51 of the upper curvable bracket 50 blocks an upper portion of a front surface of the curved liquid crystal panel 11 which is the periphery of the upper curved edge 16, and the base part 61 of the lower curvable bracket 60 blocks a lower portion of the front surface of the curved liquid crystal panel 11 which is the periphery of the lower curved edge 17.

Further, the base parts of the pair of side straight brackets 71 block left and right side portions of the front surface of the curved liquid crystal panel 11, which are side edge portions of the pair of side straight edges 18. Accordingly, the curved liquid crystal panel 11 cannot be separated from the backlight unit 20.

The curved display device 10 illustrated in FIGS. 1 to 5 includes an LCD panel including the liquid crystal panel 11 and the backlight unit 20 as a curved display panel, but embodiments of the present invention are not limited to the illustrated embodiment. The curved display device of embodiments of the present invention may also include other types of display panels such as an organic light-emitting diode (OLED) panel, a micro LED panel, and the like as the curved display panel.

Although the present invention has been disclosed in the form of embodiments and variations thereon, it will be understood that numerous additional modifications and variations could be made thereto without departing from the scope of the invention.

For the sake of clarity, it is to be understood that the use of “a” or “an” throughout this application does not exclude a plurality, and “comprising” does not exclude other steps or elements. The mention of a “unit” or a “module” does not preclude the use of more than one unit or module.

1. A curvable bracket comprising:
a base part extending along a curved edge of a curved panel; and
a plurality of pieces that are bent and protrude from one side edge of the base part to cover the curved edge, are connected to only the base part and separated from each other, and are arranged in a line in a longitudinal direction of the base part.

2. The curvable bracket of claim 1, wherein a curvature of the base part changes when an angle between a pair of neighboring pieces among the plurality of pieces changes.

3. The curvable bracket of claim 2, wherein a slit extending in a direction orthogonal to the longitudinal direction of the base part is formed between the pair of neighboring pieces, and
the angle between the pair of neighboring pieces is an angle between a pair of edges that face each other and define the slit.

4. The curvable bracket of claim 3, wherein the plurality of pieces each have a quadrangular plate shape.

5. A curved display device comprising:
a curved display panel having a screen curved in a curved shape and including at least one curved edge; and
a curvable bracket including a base part extending along the curved edge, and a plurality of pieces that are bent and protrude from one side edge of the base part to cover the curved edge, are connected to only the base part and separated from each other, and are arranged in a line in a longitudinal direction of the base part.

6. The curved display device of claim 5, comprising:
a liquid crystal panel curved in a curved shape; and
a backlight unit curved in a curved shape corresponding to the liquid crystal panel and disposed to overlap the rear of the liquid crystal panel to irradiate light toward the liquid crystal panel.

7. The curved display device of claim 6, wherein the backlight unit includes:
a backlight panel curved in a curved shape corresponding to the liquid crystal panel; and
a curved backlight bracket supported on a curved edge of the backlight panel and extending to overlap the plurality of pieces,
wherein some of the plurality of pieces are coupled to the curved backlight bracket.

8. The curved display device of claim 7, further comprising:
a chip on film having one end portion electrically connected to electrodes distributed on the liquid crystal panel; and
a source printed circuit board to which the other end portion of the COF is electrically connected.

9. The curved display device of claim 8, further comprising a PCB holder that supports the source PCB and is fixed to a back surface of the backlight panel,
wherein the COF covers the curved backlight bracket and is connected to the electrodes distributed on the liquid crystal panel and the source PCB.

10. The curved display device of claim 5, wherein a curvature of the base part changes when an angle between a pair of neighboring pieces among the plurality of pieces changes.

11. The curved display device of claim 10, wherein a slit extending in a direction orthogonal to the longitudinal direction of the base part is formed between the pair of neighboring pieces, and
the angle between the pair of neighboring pieces is an angle between a pair of edges that face each other and define the slit.

12. The curved display device of claim 11, wherein the plurality of pieces each have a quadrangular plate shape.
